(19) United States
(12) Patent Application Publication
(10) Pub. No.: US 2016/0203551 A1
(43) Pub. Date: Jul. 14, 2016

(54) METHOD AND SYSTEM FOR USING PAYMENT TRANSACTION DATA IN LOAN SOURCING

(71) Applicant: MasterCard International Incorporated, Purchase, NY (US)

(72) Inventors: Ramson TUTTE, Maynooth (IE); Peter J. Groarke, Dublin (IE); John McGuire, Spiddal (IE)

(73) Assignee: MasterCard International Incorporated, Purchase, NY (US)

(21) Appl. No.: 14/594,483

(22) Filed: Jan. 12, 2015

(51) Int. Cl. G06Q 40/02

(52) U.S. Cl. CPC G06Q 40/025

(57) ABSTRACT

A method for assisting in loan brokering using transaction data includes: storing a plurality of account profiles, wherein each account profile includes data related to a transaction account including at least an account identifier and transaction data corresponding to a plurality of payment transactions involving the related transaction account; receiving a loan request from an entity, wherein the loan request includes a specific account identifier associated with the entity and one or more requested terms; receiving a data request from a loan provider; identifying a specific account profile stored in the account database where the included account identifier corresponds to the specific account identifier; and transmitting at least the one or more requested terms included in the received loan request and the transaction data included in the identified specific account profile to the loan provider in response to the received data request.

### FIELD

The present disclosure relates to the brokering of loans that are sourced using payment card account information, specifically the collection and analysis of transaction data associated with a payment card for use in the assisting of loan brokering to a financial institution or consumer.

### BACKGROUND

Loans are sought out by merchants, consumers, and other entities for a wide variety of reasons. Some are large, long term loans, such as mortgage loans and loans for the leasing or purchase of factories and manufacturing equipment. Other loans can be smaller, short term loans, such as loans to carry a merchant or small business during a slow period or a time when additional goods need to be purchased before a heavy shopping time. For instance, some merchants may take out small, short term loans in October, to purchase additional inventory before the holiday shopping season.

In many cases, merchants and consumers that seek out loans, particularly smaller, shorter-term loans, often approach a financial institution that they are already familiar with, such as an issuing bank that holds one or more of their transaction accounts. Unfortunately, these financial institutions may not always provide the merchant or consumer with favorable terms. The merchant or consumer may thus have to approach an outside financial institution if they wish to obtain a loan with better terms. However, these other financial institutions that are not already familiar with the merchant or consumer may often be unwilling to provide a loan to someone they do not know and have very little information on. The time and expenses necessary to obtain information the financial institution requires before making a decision may outweigh the prospective profits and term of the loan being sought. As a result, merchants and consumers may be forced into accepting loans without favorable terms, and financial institutions and other loan providers may miss out on loans that they may otherwise provide and earn revenue from.

Thus, there is a need for a technical solution to assist in the brokering of loans between loan providers and loan applicants, particularly in instances where the two parties do not have a previously established relationship.

### SUMMARY

The present disclosure provides a description of systems and methods for assisting in loan brokering using transaction data.

A method for assisting in loan brokering using transaction data includes: storing, in an account database, a plurality of account profiles, wherein each account profile includes data related to a transaction account including at least an account identifier and transaction data corresponding to a plurality of payment transactions involving the related transaction account; receiving, by a receiving device, a loan request from an entity, wherein the loan request includes a specific account identifier associated with the entity and one or more requested terms; receiving, by the receiving device, a data request from a loan provider; identifying, by a processing device, a specific account profile stored in the account database where the included account identifier corresponds to the specific account identifier; and transmitting, by a transmitting device, at least the one or more requested terms included in the received loan request and the transaction data included in the identified specific account profile to the loan provider in response to the received data request.

A system for assisting in loan brokering using transaction data includes an account database, a receiving device, a processing device, and a transmitting device. The account database is configured to store a plurality of account profiles, wherein each account profile includes data related to a transaction account including at least an account identifier and transaction data corresponding to a plurality of payment transactions involving the related transaction account. The receiving device is configured to: receive a loan request from an entity, wherein the loan request includes a specific account identifier associated with the entity and one or more requested terms; and receive a data request from a loan provider. The processing device is configured to identify a specific account profile stored in the account database where the included account identifier corresponds to the specific account identifier. The transmitting device is configured to transmit at least the one or more requested terms included in the received loan request and the transaction data included in the identified specific account profile to the loan provider in response to the received data request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for assisting in loan brokering using transaction history in accordance with exemplary embodiments.

FIG. 2 is a block diagram illustrating the processing server 102 of FIG. 1 for the assisting in loan brokering using loan application transaction data in accordance with exemplary embodiments.

FIG. 3 is a flow diagram illustrating a process for identifying transaction data and calculating financial metrics for a requested loan in accordance with exemplary embodiments.

FIG. 4 is a flow diagram illustrating a process for providing financial data for requested loans and facilitating brokering of loans using transaction history in accordance with exemplary embodiments.

FIG. 5 is a flow diagram illustrating a process for pairing loan providers to requested loans using bids using the processing server of FIG. 2 in accordance with exemplary embodiments.

FIG. 6 is a flow chart illustrating an exemplary method for assisting in loan brokering using transaction data in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Assisting in Loan Brokering Using Transaction Data

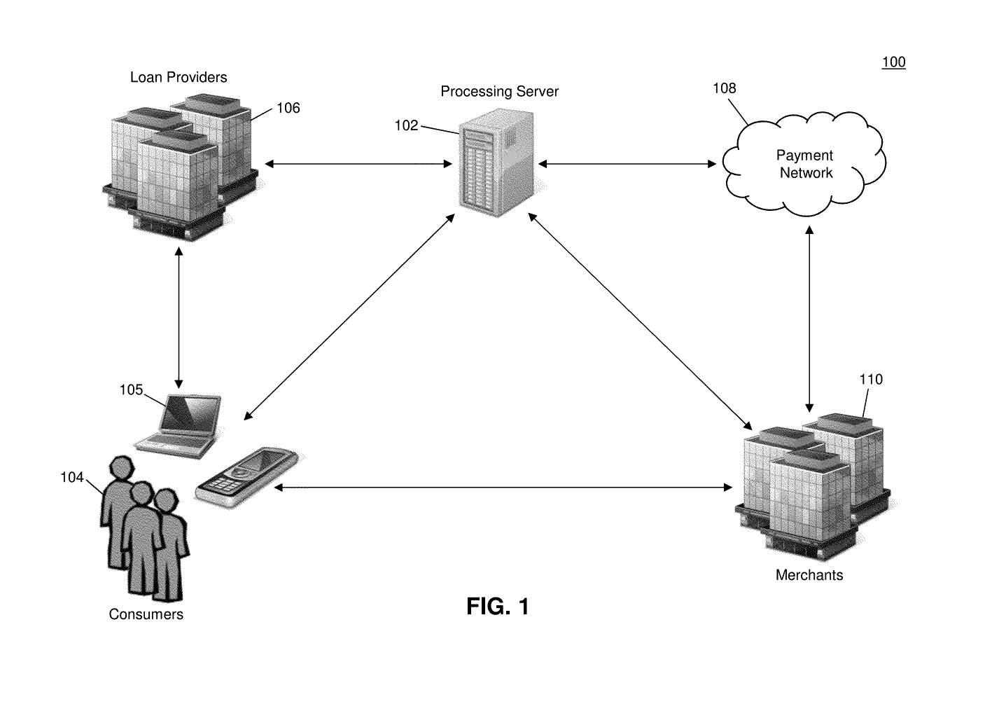

FIG. 1 illustrates a system 100 for the assisting in loan brokering between a loan applicant and a loan provider based using the applicant's transaction history.

The system 100 may include a processing server 102. The processing server 102, discussed in more detail below, may be configured to collect transaction data for a plurality of transaction accounts for analysis and use thereof to assist in the brokering of loans for entities associated with the transaction accounts. In the system 100, consumers 104 may have transaction accounts issued by one or more financial institutions, such as issuing banks. The consumers 104 may then conduct payment transactions using their associated transaction accounts with merchants 110.

The payment transactions involving the consumers 104 and merchants 110 may be processed by a payment network 108. The payment network 108 may provide transaction data for the payment transactions to the processing server 102 for use in the assisting of loan brokering. In some embodiments, the processing server 102 may be a part of the payment network 108. In further embodiments, the processing server 102 may be configured to process the payment transactions involving the consumers 104 and merchants 110, and may obtain and store transaction data as part of the processing of the payment transactions.

The consumers 104, via computing devices 105, and the merchants 110 may each apply for a loan via the submission of a loan application to the processing server 102. The loan application may include one or more terms requested by the applicant (e.g., consumer 104, merchant 110, or other suitable entity), such as repayment term, loan amount, interest rate, etc. The processing server 102 may receive the loan request, and may then identify transaction data associated with the loan applicant. The associated transaction data may be transaction data that involves the loan applicant, such as payment transactions paid for and/or paid to transaction accounts associated with the loan applicant.

In some embodiments, the processing server 102 may also perform analysis of the transaction data for the loan applicant, such as by calculating and/or identifying a plurality of financial metrics based on the transaction data. For example, the processing server 102 may calculate cash flow for the loan applicant over one or more periods of time, may estimate overall income, revenue, or expenses, may estimate their repayment capacity, may identify previous loan applications by the applicant, previous approved loans, repayment history for the loan applicant, etc. In some instances, the analysis may be performed specifically for, or with an emphasis on, the requested repayment period. For instance, if a merchant 110 requests a loan to be repaid during November and December, the processing server 102 may analyze the merchant's 110 cash flow and estimate their repayment capacity based on transaction history for November and December in previous years.

The system 100 may also include a plurality of loan providers 106. Loan providers may include financial institutions, such as issuing banks associated with the consumers 104, acquiring banks associated with the merchants 110, member financial institutions of the payment network 110, other consumers 104, other merchants 110, or any entity that may be interested in providing loans to loan applicants. The loan providers 106 may request information for one or more loan applications from the processing server 102. The processing server 102 may identify suitable loan applications (e.g., based on criteria requested by the loan provider 106) and may provide the loan applications to the loan provider 106. The processing server 102 may also include the transaction data associated with the loan application, which may include data for a plurality of payment transactions involving the loan applicant (e.g., transaction amounts, times and/or dates, geographic locations, product data, merchant data, etc.) and/or may include the calculated financial metrics.

In some embodiments, loan applicants may be able to limit the availability of transaction data and additional information, such as the calculated financial metrics. For example, a loan applicant may request that only financial institutions are able to view their transaction data, or that their full application may only be available to financial institutions for approval. In such an example, the loan applicant may prevent other consumers 104 or merchants 110 from seeing any sensitive data or from becoming their lender. In some instances, loan applicants may limit the availability of data based on the status of the loan provider 106. For example, the loan application may allow all loan providers 106 to see their business information, only financial institutions and merchants 110 to see their calculated financial metrics, and only financial institutions to see their transaction data.

The loan provider 106 may receive the loan applications and associated financial data, which may be used in a determination to accept a loan. By receiving such detailed financial information, which may be unavailable to loan providers 106 in traditional systems, the loan provider 106 may be able to make a more detailed evaluation of the loan application and the loan applicant, which may provide for a more informed decision. In addition, because the processing server 102 possesses the transaction history and can calculate these useful financial metrics, loan applicants such as the consumers 104 and merchants 105 may be able to receive loans funded by financial institutions and other loan providers 106 with whom they did not have a previous relationship. This may, in turn, result in the loan applicants receiving loans with more favorable terms, or receiving a loan they may have otherwise been denied. As a result, the processing server 102 may enable for a plurality of beneficial advantages over traditional loans via the sourcing of the loans using transaction data.

In instances where the loan application may limit the availability of data to loan providers 106, the loan provider 106 may be able to identify a loan for acceptance based thereon. For example, some loan providers 106 may decline to provide a loan to an anonymous applicant, in case the applicant is a competing merchant 110. In another example, a loan provider 106 may only be interested in providing loans to consumers 104 and not merchants 110 or may only wish to see loan applications where transaction data is available. In some instances, the processing server 102 may provide filters to the loan provider 106 for receiving and/or viewing loan applications. For example, the processing server 102 may filter out all loan applications for which transaction data is not available to the loan provider 106, at the request of the loan provider 106. As a result, the use of limits by the loan applicants may provide significant benefits to both the loan applications and loan providers 106 in terms of privacy and convenience.

In some embodiments, if a loan provider 106 identifies a loan application that they would like to fund, they may notify the processing server 102. The processing server 102 may then generate the necessary loan documents and circulate them to the loan provider 106 and the loan applicant, in order to further assist in the facilitating of the loan. In some instances, the processing server 102 may notify the payment network 108 to initiate a payment transaction for payment of the loan amount from the loan provider 106 to the loan applicant to further assist in the processing of the loan. In embodiments where the processing server 102 may be a part of the payment network 108, the processing server 102 may initiate the processing of payment of the loan itself.

In some embodiments, the processing server 102 may also be configured to facilitate bidding on loan applications. In such an embodiment, loan providers 106 may submit bids for a loan application, which may be stored by the processing server 102 and processed in order to identify a suitable loan provider 106 for a specific loan application. In some instances, the processing of bids may be based on terms included in the loan application as provided by the applicant. For example, a loan applicant may be interested in the first bid that accepts each of the applied for terms. In another example, the loan applicant may request a bid be accepted that is the most favorable with respect to one or more of the requested terms. For instance, a loan applicant may request a bid be accepted that has the most favorable interest rate, or a combination of interest rate and repayment term. Thus, the use of bids may enable the processing server 102 to provide even further benefits to loan applicants, and may also assist loan providers 106 that are able to offer favorable terms to accept additional loans that may otherwise not obtain.

### Processing Server

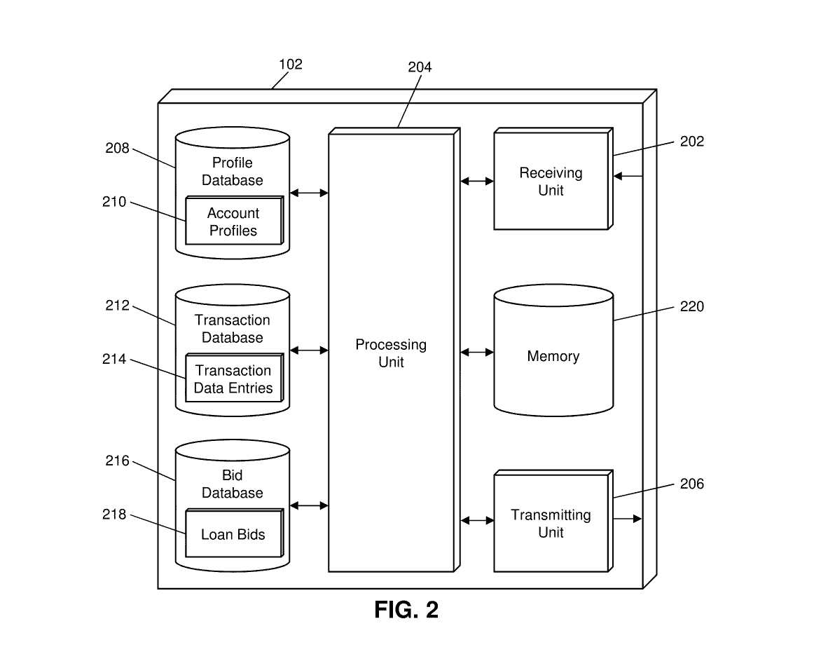

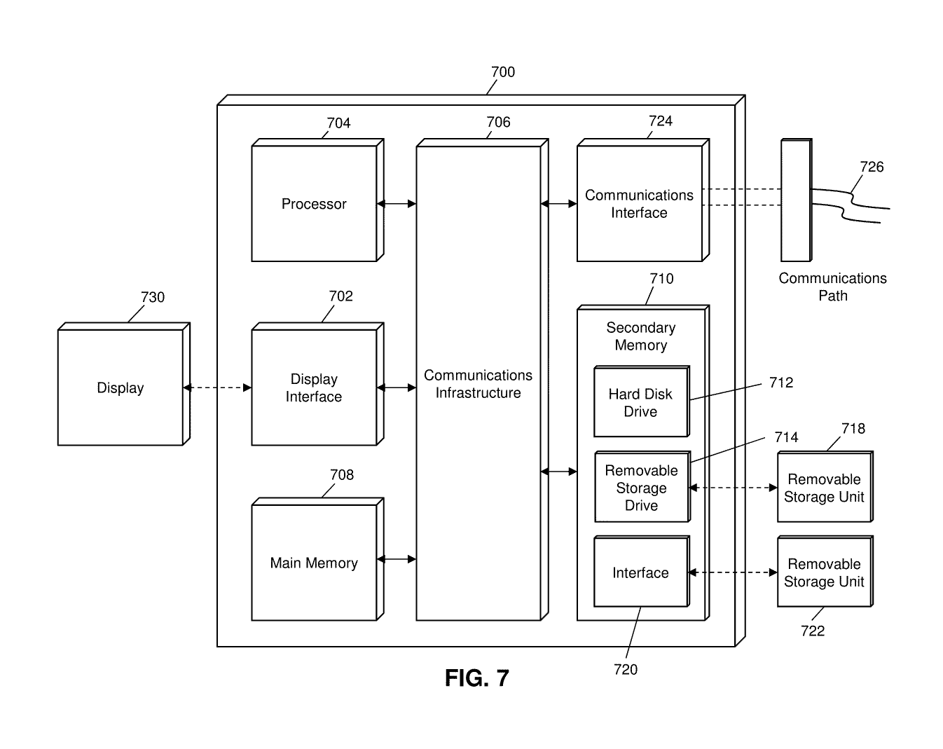

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 7 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive transaction data for a plurality of payment transactions, loan applications and/or loan request terms from loan applicants (e.g., consumers 104, merchants 110, etc.), data requests from loan providers 106 requesting information on loan applications, loan acceptances or bids from loan providers 106, documentation provided by loan applicants and/or loan providers 106, etc. The receiving unit 202 may also receive additional data for use in the brokering of loans, such as rules and regulations that may be used by the processing server 102 in the performing of the functions discussed herein.

The processing server 102 may further include a processing unit 204. The processing unit 204 may be configured to perform the functions of the processing server 102 discussed herein as will be apparent to persons having skill in the relevant art. The processing server 102 may be configured to generate a plurality of account profiles 210 for storage in a profile database 208 in the processing server 102. The profile database 208 may include a plurality of account profiles 210, wherein each account profile includes data related to a transaction account including at least an account identifier and transaction data. The account identifier may be a unique value suitable for identification of the account profile 210 and/or associated transaction account, such as a transaction account number, identification number, username, e-mail address, merchant identification number, tax identification number, etc. The transaction data may include data for a plurality of payment transactions involving the associated transaction account, and/or may include financial metrics calculated by the processing unit 204.

In some embodiments, the processing server 102 may also include a transaction database 212. The transaction database 212 may include a plurality of transaction data entries 214. Each transaction data entry 214 may include data related to a payment transaction, and may include one or more account identifiers associated with a transaction account involved in the related payment transaction. The processing unit 204 may be configured to identify an account profile 210 associated with a transaction data entry 214, based on the included account identifiers, for use in calculating transaction data and financial metrics for including in the account profile 210. In some instances, a single transaction data entry 214 may be used in the calculation of transaction data for at least two account profiles 210, such as an account profile 210 for the payer and another account profile 210 for the payee of a payment transaction.

In embodiments where the processing server 102 may process bids for loan applicants, the processing server 102 may also include a bid database 216. The bid database 216 may include a plurality of loan bids 218. Each loan bid may be associated with a loan application and include one or more accepted terms provided by the associated loan provider 106. The processing unit 204 may be configured to identify each loan bid 218 associated with a specific loan application and may be configured to identify a bid to be accepted out of each of the loan bids 218. The bid to be accepted may be based on information included in the loan application or may be identified by the processing unit 204 using one or more rules or algorithms used thereby, which may be stored in a memory 220.

The memory 220 may be configured to store data suitable for use in performing the functions of the processing server 102 discussed herein. For example, the memory 220 may be configured to store rules and/or algorithms for the identification of accepted bids, for the calculation of financial metrics, for the identification of suitable loan applications, for the generation of loan documentation, for the processing of loan payments, for the processing of loan repayments, etc. Additional data that may be stored in the memory 220 will be apparent to persons having skill in the relevant art.

The processing server 102 may also include a transmitting unit 206. The transmitting unit 206 may be configured to transmit data over one or more networks via one or more network protocols. The transmitting unit 206 may transmit loan applications and transaction data associated thereby as identified by the processing unit 204 to loan providers 106 in response to received data requests. The transmitting unit 206 may also be configured to transmit loan documentation to loan applicants and loan providers for accepted loans. In some embodiments, the transmitting unit 206 may also be configured to transmit authorization requests to the payment network 108 for loan payments to be made from the loan provider 106 to the applicant.

In some embodiments, the processing server 102 may be configured to assist in the repayment of a loan that was brokered using the methods and systems discussed herein. In such an embodiment, the receiving unit 202 may receive one or more repayment terms from the loan applicant and/or loan provider 106 or an agreement based thereon. The processing unit 204 may then initiate processing of payments from the loan applicant to the loan provider 106 pursuant to the repayment terms, such as initiating a payment transaction of a specific amount at predetermined times. In some embodiments, the processing unit 204 may be configured to calculate a repayment schedule based on the loan applicant's transaction data, which may be used in the facilitation of repayment for the brokered loan.

It will be apparent to persons having skill in the relevant art that the processing server 102 may include additional and/or alternative components to the components illustrated in FIG. 2 and discussed herein, and that the components illustrated in FIG. 2 may be further configured to perform additional functions. For example, in embodiments where the processing server 102 may be configured to process payment transactions for the payment network 108, the components of the processing server 102 may be further configured to perform additional functions necessary for the processing of payment transactions, such as the receiving and transmitting of authorization requests and responses, processing and application of fraud rules, etc.

In some embodiments, the processing server 102 and components included therein may be further configured to perform functions associated with the repayments of a loan. For instance, the processing server 102 may be configured to process automatic repayments via initiation of payment transactions for loan repayments using the payment network 108. In another example, the processing server 102 may be configured to garnish wages received by the applicant. In such an example, if the payment network 108 identifies an income payment directed to the applicant, the processing unit 204 may be configured to garnish a portion of the income payment for payment to the loan provider 106 as repayment for the loan. In such an instance, garnishment amounts, frequency, etc. may be identified via the processing unit 204, such as using rules stored in the memory 220, using methods that will be apparent to persons having skill in the relevant art.

In some instances, the processing server 102 may be configured to provide post loan payment information to the loan provider 106, such as for use by the loan provider 106 in recovering repayment of the loan. For instance, the processing unit 204 may identify payment transactions involving the loan applicant following payment of the loan by the loan provider 106, and may provide the transaction data (e.g., via the transmitting unit 206) or information obtained via analysis thereof to the loan provider 106. For example, the processing server 102 may provide data to the loan provider 106 indicating that the loan applicant has received enough revenue to cover a repayment, which may be used by the loan provider 106 in recovering funds from the loan applicant in instances where the applicant may refuse to repay or default on the loan repayment. In another example, the processing unit 204 may identify that a loan applicant has not received enough income to cover a repayment, and may notify the loan provider 106 when the loan applicant is capable of covering a repayment amount.

### Processing Loan Applications

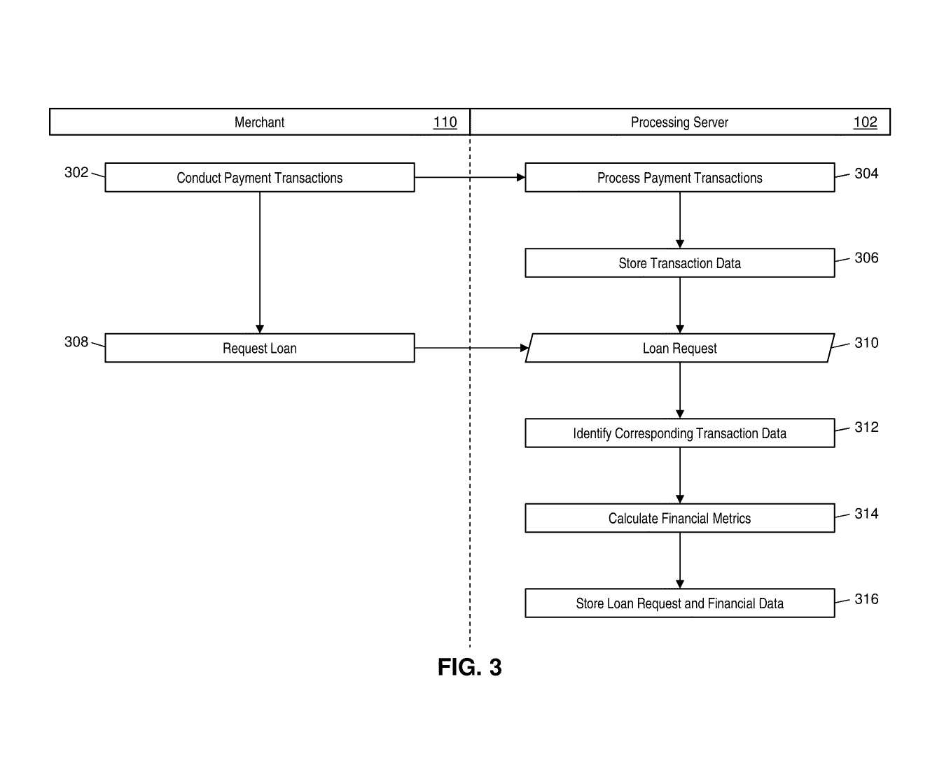

FIG. 3 illustrates a process for the processing of loan applications received from a loan applicant in the system 100. As illustrated in FIG. 3 and discussed herein, the loan application may be a merchant 110. It will be apparent to persons having skill in the relevant art that the loan applicant may be any applicant for which the processing server 102 may receive and analyze transaction data, such as a consumer 104 or other suitable entity, and that the inclusion of the merchant 110 in the process illustrated in FIG. 3 is used for illustration.

In step 302, the merchant 110 may conduct a plurality of payment transactions. The payment transactions may be for the purchase of goods or services as well as for the sale of goods or services. In step 304, the processing server 102 (e.g., or payment network 108) may process the payment transactions involving the merchant 110 as they are conducted. In step 306, transaction data for each of the payment transactions may be stored by the processing server 102, such as in the transaction database 212 as transaction data entries 214 or in an account profile 210 in the profile database 208 associated with the merchant 110.

In step 308, the merchant 110 may submit a loan request to the processing server 102. In step 310, the receiving unit 202 of the processing server 102 may receive the loan request. The loan request may include one or more requested terms, and may also include an account identifier associated with the account profile 210 associated with the merchant 110 for use in identification by the processing unit 204 of the processing server 102. The one or more requested terms may include repayment period, repayment amount, loan amount, interest rate, etc. In some instances, a requested term may include a range of values, such as a range of interest rates acceptable to the merchant 110. In instances where the merchant 110 may request loan providers 106 bid on the requested loan, the loan request may also include one or more bid rules, such as for the identification of an accepted bid by the processing unit 204.

In step 312, the processing unit 204 may identify transaction data corresponding to the loan request. The identification of transaction data may include identifying transaction data included in the account profile 210 associated with the merchant 110 that includes the account identifier included in the received loan request. The identification of transaction data may also include identifying transaction data entries 214 in the transaction database 212 that include the account identifier. In some embodiments, the processing unit 204 may also filter transaction data that is identified based on one or more of the requested terms included in the received loan request, such as by identifying transactions conducted during an equivalent of the requested repayment period.

In step 314, the processing unit 204 may calculate a plurality of financial metrics based on the identified transaction data. The financial metrics may be calculated using one or more rules or algorithms stored in the memory 220 and may include profit, revenue, cash flow, capacity for repayment, estimated future profit, revenue, or cash flow, etc. In step 316, the loan request and the calculated financial metrics may be stored (e.g., in the memory 220 or an additional loan database included in the processing server 102) for future use. In some instances, the identified transaction data may also be stored with the loan request.

### Processing of Loan Acceptance

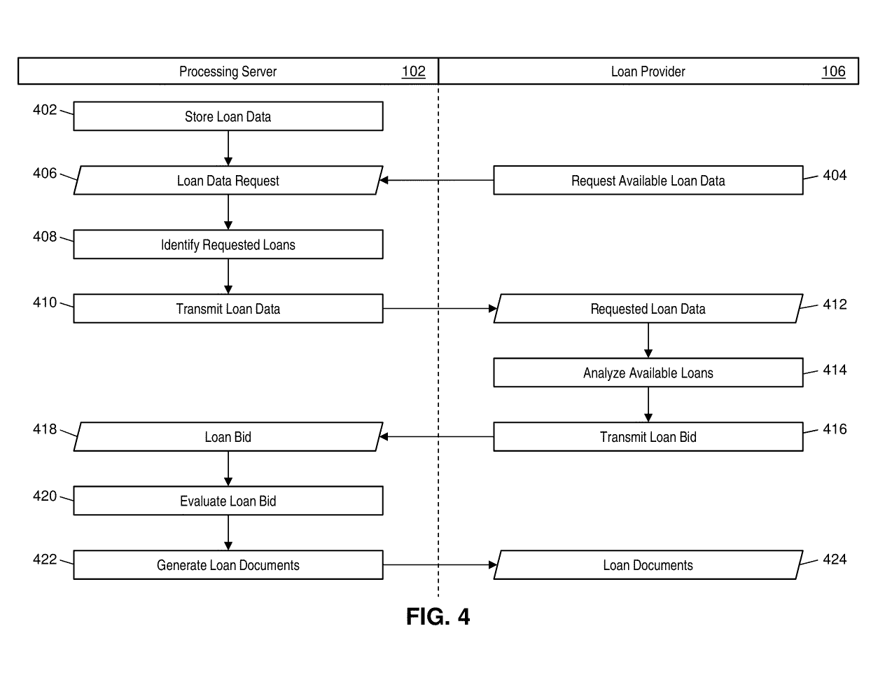

FIG. 4 illustrates a process for the identification of a loan application and acceptance thereof by a loan provider 106 in the system 100 of FIG. 1.

In step 402, the processing server 102 may store loan data. The loan data may include one or more requested terms for the loan and financial data, such as is stored in step 316 of the process illustrated in FIG. 3 and discussed above. In step 404, a loan provider 106 may submit a request for available loan data. In some instances, the request may include one or more loan criteria, such as criteria for which the loan provider 106 is willing to provide a loan. For example, a loan provider 106 may request data only for loans that are below a specific loan amount.

In step 406, the receiving unit 202 of the processing server 102 may receive the loan data request. In step 408, the processing unit 204 may identify loan applications that fit the criteria included in the received loan data request. In step 410, the transmitting unit 206 of the processing server 102 may transmit loan data to the loan provider 106. In step 412, the loan provider 106 may receive the loan data. The loan data may include the loan applications or data included therein for each identified loan application that fit the criteria, as well as the financial data associated thereto, which may include transaction data and/or financial metrics associated with the applicant.

In step 414, the loan provider 106 may analyze each of the available loans via the loan applications and accompanying transaction data and may identify a loan that the loan provider 106 wants to accept. In step 416, the loan provider 106 may transmit a bid for the identified loan to the processing server 102. In step 418, the receiving unit 202 may receive the bid. The bid may include one or more acceptance terms, which may correspond to the one or more requested terms for the loan and may include additional or alternative terms.

In step 420, the processing unit 204 may evaluate the loan bid provided by the loan provider 106. Evaluation of the loan bid may include comparing the one or more acceptance terms to the one or more requested terms to ensure that the bid is within acceptable ranges and is otherwise in compliance with the request of the loan applicant. If the bid is suitable, then, in step 422, the processing unit 204 may generate loan documents associated with the loan. The loan documents may include any documentation that may be necessary for completion by the loan provider 106 to facilitate acceptance and payment of the loan. The transmitting unit 206 may transmit the generated loan documents to the loan provider 106, which may receive the documents in step 424.

### Processing of Loan Bids

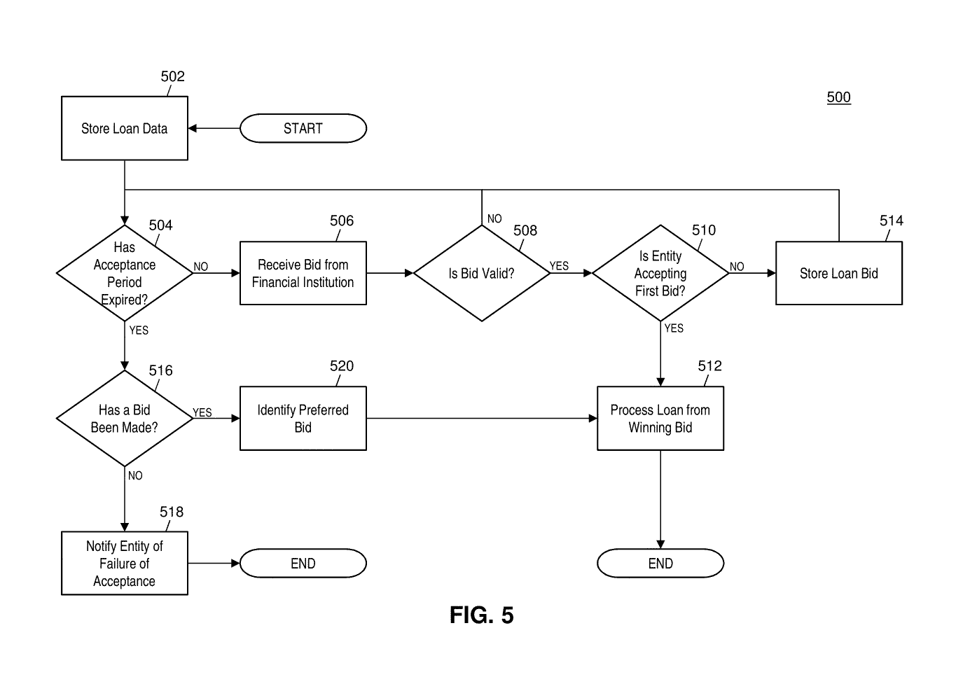

FIG. 5 illustrates a process 500 for the evaluation and processing of bids for a loan application by the processing server 102.

In step 502, the processing unit 204 of the processing server 102 may store loan data for a loan application from an applicant (e.g., the consumer 104, merchant 110, or other suitable entity). The loan data may include at least the loan application and one or more requested terms. In some instances, the one or more requested terms may include one or more bid criteria that may be used to specify if and/or when a bid should be accepted.

In step 504, the processing unit 204 may determine if an acceptance period for a loan application has expired. The acceptance period may be one of the one or more requested terms of the loan application, or may be set by the processing server 102 or by another source (e.g., rules or regulations) that may specify a period of time in which a loan application must be accepted before expiring. If the acceptance period has not expired, then, in step 506, the receiving unit 202 may receive a loan bid from a financial institution or other loan provider 106 (e.g., a consumer 104, merchant 110, or other suitable entity).

In step 508, the processing unit 204 may determine if the bid is valid. The bid may be valid if one or more acceptance terms received in the bid comply with the one or more requested terms. If the bid is not valid, then the bid may not be considered and the process 500 may return to step 504 to await ending of the acceptance period and receipt of new bids. If the bid is valid, then, in step 510, the processing unit 204 may determine if the first bid for the loan application is to be accepted.

The determination may be based on the one or more requested terms or other suitable data, such as policies set by the processing server 102 for the acceptance of bids, etc. If the first bid is not to be accepted, then, in step 514, the bid may be stored by the processing unit 204 in the bid database 216. If the first valid bid is to be accepted, then, in step 512, the processing unit 204 may process the loan from the first bid as a winning bid. Processing of the loan may include generating loan documentation, initiating payment of the loan amount, notifying the loan applicant and the loan provider 106, and other actions that will be apparent to persons having skill in the relevant art.

If, in step 504, it is determined by the processing unit 204 that the period for acceptance of a loan application has been expired and a winning bid has not yet been processed, then, in step 516, the processing unit 204 may determine if there is a valid bid outstanding for the loan application. If there are no valid bids, such as loan bids 218 in the bid database 216 associated with the loan application, then, in step 518, the transmitting unit 206 may transmit a notification to the applicant that their loan application was not accepted. In some instances, the loan applicant may be provided with an opportunity to resubmit their application, which may include the modification of one or more of the requested terms.

If a valid bid had been made for the loan application, then, in step 520, the processing unit 204 may identify a preferred bid from all of the loan bids 218 associated with the loan application. The preferred bid may be identified based on one or more rules or algorithms for identification of preferred bids stored in the memory 220, which may also consider one or more criteria set by the applicant in the original loan application request. Once the preferred bid has been identified, then the process 500 may proceed to step 512 where the loan is processed using the preferred bid.

In some embodiments, in step 520 the processing unit 204 may rank the loan bids 218 associated with the loan application and present the loan bids 218 as ranked, and/or an identified preferred bid, to the loan applicant prior to acceptance. In such an embodiment, the loan applicant may be able to identify the loan provider 106 and loan bid 218 they prefer to accept, which may be assisted by the preference ranking provided by the processing unit 204. In some instances, a loan applicant may request that the processing unit 204 automatically accept the loan bid 218 identified as the preferred bid, with the process 500 proceeding to step 512 automatically. In other instances, the processing server 102 may await receipt (e.g., via the receiving unit 202) of confirmation or selection of the preferred bid by the loan application prior to proceeding to step 512.

### Exemplary Method for Assisting in Loan Brokering Using Transaction Data

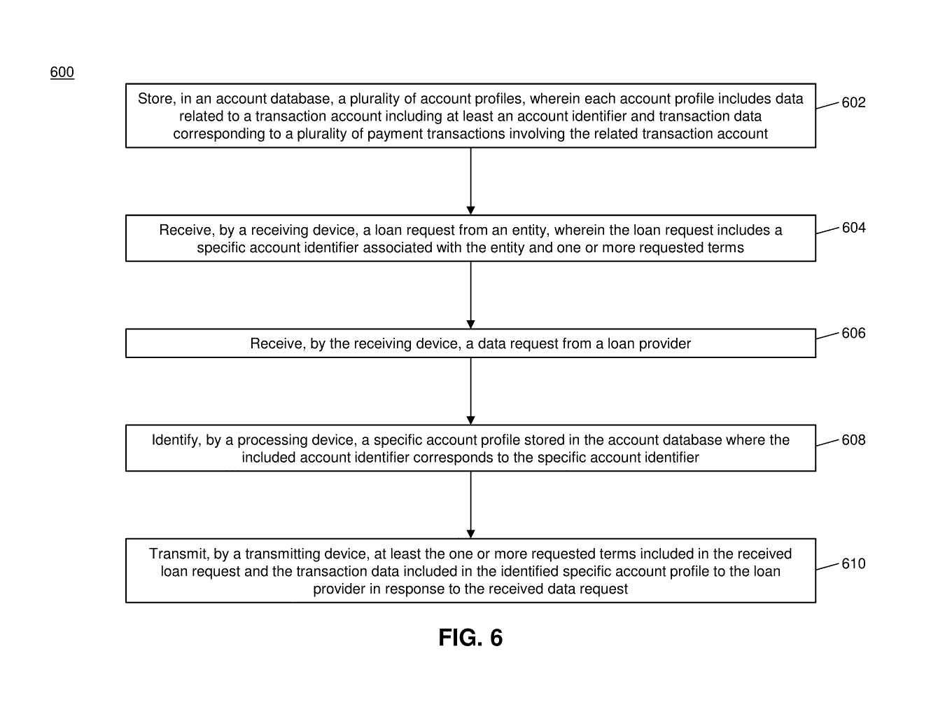

FIG. 6 illustrates a method 600 for the assisting in loan brokering using transaction data associated with an entity for whom a loan is requested.

In step 602, a plurality of account profiles (e.g., account profiles 210) may be stored in an account database (e.g., the profile database 208), wherein each account profile 210 includes data related to a transaction account including at least an account identifier and transaction data corresponding to a plurality of payment transactions involving the related transaction account. In step 604, a loan request may be received from an entity by a receiving device (e.g., the receiving unit 202), wherein the loan request includes a specific account identifier associated with the entity and one or more requested terms.

In step 606, a data request may be received by the receiving device 202 from a loan provider (e.g., the loan provider 106). In step 608, a specific account profile 210 stored in the account database 208 may be identified by a processing device (e.g., the processing unit 204) where the included account identifier corresponds to the specific account identifier. In step 610, at least the one or more requested terms included in the received loan request and the transaction data included in the identified specific account profile may be transmitted by a transmitting device (e.g., the transmitting unit 206) to the loan provider 106 in response to the received data request.

In some embodiments, the account database 208, the receiving unit 202, the processing device 204, and the transmitting device 206 may be included as part of a payment network (e.g., the payment network 108). In a further embodiment, the transaction data included in each account profile 210 may be obtained via the processing of the corresponding payment transactions by the payment network 108. In another further embodiment, the loan provider 106 may be a member of the payment network 108.

In one embodiment, the method 600 may further include: storing, in a transaction database (e.g., transaction database 212), a plurality of transaction data entries (e.g., transaction data entries 214), wherein each transaction data entry 214 includes data related to a payment transaction including at least an involved account identifier and transaction data; and identifying, for each account profile 210, the transaction data corresponding to a plurality of payment transactions involving the related transaction account based on the transaction data included in a subset of the plurality of transaction data entries 214 stored in the transaction database 212 where the included involved account identifier corresponds to the account identifier included in the respective account profile. In a further embodiment, the identified transaction data includes at least one of: purchase behavior, cash flow, estimated income, revenue, spending over time, and estimated repayment capacity.

In some embodiments, the method 600 may also include: receiving, by the receiving device 202, a loan acceptance confirmation from the loan provider 106; generating, by the processing device 204, one or more loan contracts, wherein each of the one or more loan contracts includes data based on the received data request, the received loan acceptance, and the one or more requested terms included in the received loan request; and transmitting, by the transmitting device 206, the generated one or more loan contracts to at least one of: the loan provider 106 and the entity. In a further embodiment, the method 600 may also include processing, by the processing device 204, a payment transaction for payment of a loan amount from the loan provider 106 to the entity, wherein the loan amount is included in the one or more requested terms included in the received loan request.

In one embodiment, the method 600 may further include: storing, in a bid database (e.g., the bid database 216), a plurality of loan bids (e.g., loan bids 218), wherein each loan bid 218 includes data related to a bid for a loan corresponding to the received loan request and associated with a specific loan provider 106 including at least one or more loan acceptance terms; receiving, by the receiving device 202, a loan bid request from the loan provider 106, wherein the loan bid request includes one or more acceptance terms; and storing, in the bid database 216, a new loan bid 218, wherein the new loan bid 218 is associated with the loan provider 106 and includes the one or more acceptance terms included in the received loan bid request. In a further embodiment, the method 600 may even further include: identifying, by the processing device 204, an accepted bid of the plurality of loan bids 218 stored in the bid database 216 based on at least the one or more acceptance terms included in each loan bid 218 stored in the bid database 216; generating, by the processing device 204, one or more loan contracts, wherein each of the one or more loan contracts includes data based on the received data request, the one or more acceptance terms included in the identified accepted bid, and the one or more requested terms included in the received loan request; and transmitting, by the transmitting device 206, the generated one or more loan contracts to at least one of: the loan provider 106 associated with the identified accepted bid and the entity.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, which may be hosted and/or stored locally and/or externally and may include public and/or private infrastructure, including cloud-based infrastructure, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for assisting in loan brokering using transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for assisting in loan brokering using transaction data, comprising:
storing, in an account database, a plurality of account profiles, wherein each account profile includes data related to a transaction account including at least an account identifier and transaction data corresponding to a plurality of payment transactions involving the related transaction account;
receiving, by a receiving device, a loan request from an entity, wherein the loan request includes a specific account identifier associated with the entity and one or more requested terms;
receiving, by the receiving device, a data request from a loan provider;
identifying, by a processing device, a specific account profile stored in the account database where the included account identifier corresponds to the specific account identifier; and
transmitting, by a transmitting device, at least the one or more requested terms included in the received loan request and the transaction data included in the identified specific account profile to the loan provider in response to the received data request.

2. The method of claim 1, wherein the account database, the receiving device, the processing device, and the transmitting device are included as part of a payment network.

3. The method of claim 2, wherein the transaction data included in each account profile is obtained via the processing of the corresponding payment transactions by the payment network.

4. The method of claim 2, wherein the loan provider is a member of the payment network.

5. The method of claim 1, further comprising:
storing, in a transaction database, a plurality of transaction data entries, wherein each transaction data entry includes data related to a payment transaction including at least an involved account identifier and transaction data; and
identifying, for each account profile, the transaction data corresponding to a plurality of payment transactions involving the related transaction account based on the transaction data included in a subset of the plurality of transaction data entries stored in the transaction database where the included involved account identifier corresponds to the account identifier included in the respective account profile.

6. The method of claim 5, wherein the identified transaction data includes at least one of: purchase behavior, cash flow, estimated income, revenue, spending over time, and estimated repayment capacity.

7. The method of claim 1, further comprising:
receiving, by the receiving device, a loan acceptance confirmation from the loan provider;
generating, by the processing device, one or more loan contracts, wherein each of the one or more loan contracts includes data based on the received data request, the received loan acceptance, and the one or more requested terms included in the received loan request; and
transmitting, by the transmitting device, the generated one or more loan contracts to at least one of: the loan provider and the entity.

8. The method of claim 7, further comprising:
processing, by the processing device, a payment transaction for payment of a loan amount from the loan provider to the entity, wherein the loan amount is included in the one or more requested terms included in the received loan request.

9. The method of claim 1, further comprising:
storing, in a bid database, a plurality of loan bids, wherein each loan bid includes data related to a bid for a loan corresponding to the received loan request and associated with a specific loan provider including at least one or more acceptance terms;
receiving, by the receiving device, a loan bid request from the loan provider, wherein the loan bid request includes one or more acceptance terms; and
storing, in the bid database, a new loan bid, wherein the new loan bid is associated with the loan provider and includes the one or more acceptance terms included in the received loan bid request.

10. The method of claim 9, further comprising:
identifying, by the processing device, an accepted bid of the plurality of loan bids stored in the bid database based on at least the one or more acceptance terms included in each loan bid stored in the bid database;
generating, by the processing device, one or more loan contracts, wherein each of the one or more loan contracts includes data based on the received data request, the one or more acceptance terms included in the identified accepted bid, and the one or more requested terms included in the received loan request; and
transmitting, by the transmitting device, the generated one or more loan contracts to at least one of: the loan provider associated with the identified accepted bid and the entity.

11. A system for assisting in loan brokering using transaction data, comprising:
an account database configured to store a plurality of account profiles, wherein each account profile includes data related to a transaction account including at least an account identifier and transaction data corresponding to a plurality of payment transactions involving the related transaction account;
a receiving device configured to
receive a loan request from an entity, wherein the loan request includes a specific account identifier associated with the entity and one or more requested terms, and
receive a data request from a loan provider;
a processing device configured to identify a specific account profile stored in the account database where the included account identifier corresponds to the specific account identifier; and
a transmitting device configured to transmit at least the one or more requested terms included in the received loan request and the transaction data included in the identified specific account profile to the loan provider in response to the received data request.

12. The system of claim 11, wherein the account database, the receiving device, the processing device, and the transmitting device are included as part of a payment network.

13. The system of claim 12, wherein the transaction data included in each account profile is obtained via the processing of the corresponding payment transactions by the payment network.

14. The system of claim 12, wherein the loan provider is a member of the payment network.

15. The system of claim 11, further comprising:
a transaction database configured to store a plurality of transaction data entries, wherein each transaction data entry includes data related to a payment transaction including at least an involved account identifier and transaction data, wherein
the processing device is further configured to identify, for each account profile, the transaction data corresponding to a plurality of payment transactions involving the related transaction account based on the transaction data included in a subset of the plurality of transaction data entries stored in the transaction database where the included involved account identifier corresponds to the account identifier included in the respective account profile.

16. The system of claim 15, wherein the identified transaction data includes at least one of: purchase behavior, cash flow, estimated income, revenue, spending over time, and estimated repayment capacity.

17. The system of claim 11, wherein
the receiving device is further configured to receive a loan acceptance confirmation from the loan provider,
the processing device is further configured to generate one or more loan contracts, wherein each of the one or more loan contracts includes data based on the received data request, the received loan acceptance, and the one or more requested terms included in the received loan request, and
the transmitting device is further configured to transmit the generated one or more loan contracts to at least one of: the loan provider and the entity.

18. The system of claim 17, wherein the processing device is further configured to process a payment transaction for payment of a loan amount from the loan provider to the entity, wherein the loan amount is included in the one or more requested terms included in the received loan request.

19. The system of claim 11, further comprising:
a bid database configured to store a plurality of loan bids, wherein each loan bid includes data related to a bid for a loan corresponding to the received loan request and associated with a specific loan provider including at least one or more acceptance terms, wherein
the receiving device is further configured to receive a loan bid request from the loan provider, wherein the loan bid request includes one or more acceptance terms, and
the processing device is further configured to store, in the bid database, a new loan bid, wherein the new loan bid is associated with the loan provider and includes the one or more acceptance terms included in the received loan bid request.

20. The system of claim 19, wherein
the processing device is further configured to
identify an accepted bid of the plurality of loan bids stored in the bid database based on at least the one or more acceptance terms included in each loan bid stored in the bid database, and
generate one or more loan contracts, wherein each of the one or more loan contracts includes data based on the received data request, the one or more acceptance terms included in the identified accepted bid, and the one or more requested terms included in the received loan request, and
the transmitting device is further configured to transmit the generated one or more loan contracts to at least one of: the loan provider associated with the identified accepted bid and the entity.
